(19) United States
(12) Patent Application Publication
(10) Pub. No.: US 2007/0167082 A1
(43) Pub. Date: Jul. 19, 2007

(54) Structure and method for increasing locking friction force on circuit board

(75) Inventor: Chih-Feng Yeh, Taipei Hsien (TW)

Correspondence Address: TROXELL LAW OFFICE PLLC, 5205 LEESBURG PIKE, SUITE 1404, FALLS CHURCH, VA, 22041, US

(73) Assignee: WISTRON CORP.

(21) Appl. No.: 11/519,225

(22) Filed: Sep. 12, 2006

(30) Foreign Application Priority Data
Jan. 16, 2006 (TW) 095101596

(51) Int. Cl. H01R 33/00

(52) U.S. Cl. 439/638

(57) ABSTRACT

A structure and method for increasing a locking friction force on a circuit board allow a connecting face to be disposed on at least one of upper and lower faces of a substrate at a clamped position, the connecting face having a multiple relative indented portions and raised portions interlacing structure so as to allow the connecting face to have a larger friction coefficient. Whereby, when the connecting face is clamped, a larger friction force is exerted thereon and a displacement relative to a clamper is rather not yielded.

### BACKGROUND OF THE INVENTION

1. Field of the Invention

The present invention relates to a structure for locking a circuit board on a housing of an electronic device, and more particularly to a structure and method for increasing a locking friction force on a circuit board.

2. Description of Related Art

There are many patents concerning mounting a circuit board on a housing of an electronic device, such as U.S. Pat. No. 6,934,162 entitled as “Circuit board mounting method”, U.S. Pat. No. 6,781,055 entitled as “Circuit board mounting device” and U.S. Pat. No. 6,771,512 entitled as “Mounting system for circuit board”.

Furthermore, for example, Taiwan Patent No. 562,390 discloses a circuit board with an element fixing device in which holes are opened. A fixing element has a substrate and a connecting portion extended outward from one side of the substrate; screw holes communicated between the substrate and the connecting portions are disposed therein. A welding pad engaged at the outside of the connecting element is welded to the substrate. The connecting portions are accepted in the holes of the circuit board. A bolt is used to screw in the screw hole communicating the substrate with the connecting portion to allow the circuit board to be fixed on the fixing element.

Please refer to FIG. 1. A bolt 11 is passed through holes 121 and 131 of a first housing 12 and a circuit board 13 in a sequence and then screwed into screw hole 142 of the projecting portion 141 of a second housing 14 in a general electronic device 10 to cause the circuit board 13 to be sandwiched between the first housing 12 and the projecting portion 141 of the second housing 14.

Because a gap still exists between the through hole 131 of the circuit board 13 and the bolt 11, when the electronic device 10 is dropped to touch a floor 20, the circuit board 13 and an electronic component 15 such as a switch still move downward owing to acceleration of gravity, and the first housing 12, the second housing 14 and another electronic component 16 such as a key combined with the first housing 12 and the second housing 14 are moved upward because they are exerted with a reaction force while touching the floor 20, two electronic components 15 and 16 will touch each other to cause soldering tin welded on the electronic component 15 and the circuit board 13 to be fallen off or the electronic components 15 and 16 to be deformed to loose functions.

Please refer to FIG. 2. A tin ring 132 is disposed around the through hole 131 used for allowing a bolt to be passed through in a general circuit board 13 sometimes owing to the requirement of electric current conduction; but the whole tin ring 132 is usually flat, it is rather not able to increase a friction force when the circuit board 13 is locked.

### SUMMARY OF THE INVENTION

For improving a conventional structure for locking a circuit board on an electronic device, the present invention is proposed.

The main object of the present invention is to provide a structure and method for increasing a locking friction force on a circuit board, allowing the circuit board to be combined stably with a housing of an electronic device.

Another object of the present invention is to provide a structure and method for increasing a locking friction force on a circuit board, allowing a displacement rather not to be generated between the circuit and a housing when an electronic device is dropped down onto a floor to cause components assembled on the circuit board rather not to touch the housing or other electronic components mounted on the housing to cause damage or loose functions.

The present invention provides a structure for increasing a locking friction force on a circuit board, allowing a larger friction coefficient to be existed at a position where a substrate is clamped; comprising: the substrate, a connecting face being disposed on at least one of upper and lower faces thereof at the clamped position, the connecting face having a multiple relative indented portions and raised portions interlacing structure so as to allow the connecting face to have a larger friction coefficient, when the connecting face is clamped, a larger friction force being exerted thereon and a displacement relative to a clamper being rather not yielded.

The present invention provides a method for increasing a locking friction force on a circuit board, allowing a larger friction coefficient to be existed at a position where a substrate is clamped; comprising: allowing a connecting face with a multiple relative raised portions and indented portions interlacing structure to be formed on at least one of upper and lower faces of the substrate at the clamped position so as to allow the connecting face to have a larger friction coefficient, when the connecting face is clamped, a larger friction force being exerted thereon and a displacement relative to a clamper being rather not yielded.

### BRIEF DESCRIPTION OF THE DRAWINGS

The present invention can be more fully understood by reference to the following description and accompanying drawings, in which:

FIG. 1 is a schematic view of a mounting structure of a conventional circuit board when a housing touches a floor;

FIG. 2 is a schematic view, showing a tin ring disposed around a through hole of a conventional circuit board;

FIG. 3 is a schematic view, showing a substrate mounting structure of a first preferred embodiment according to the present invention;

FIG. 4 is a schematic view, showing a substrate mounting structure of a second preferred embodiment according to the present invention; and

FIGS. 5A, 5B, 5C and 5D are schematic views, showing connecting faces of substrates of various preferred embodiments according to the present invention.

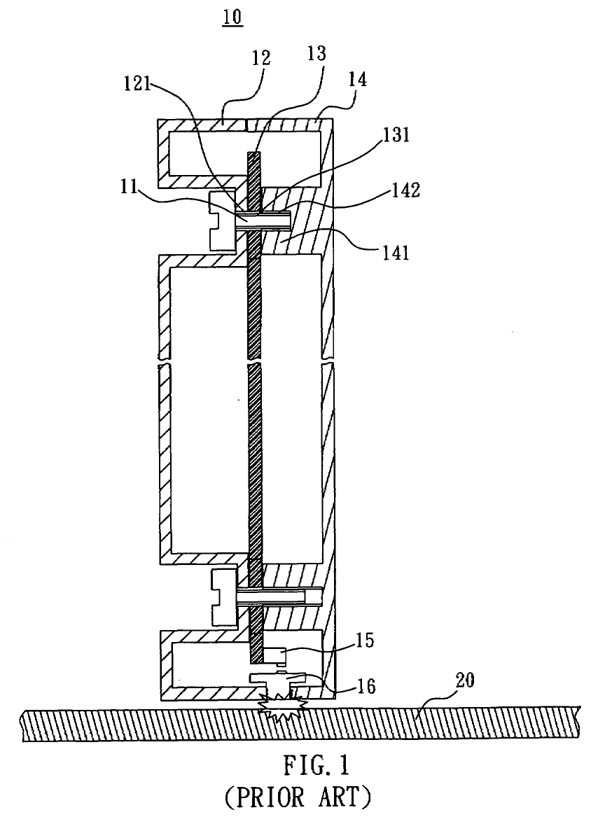

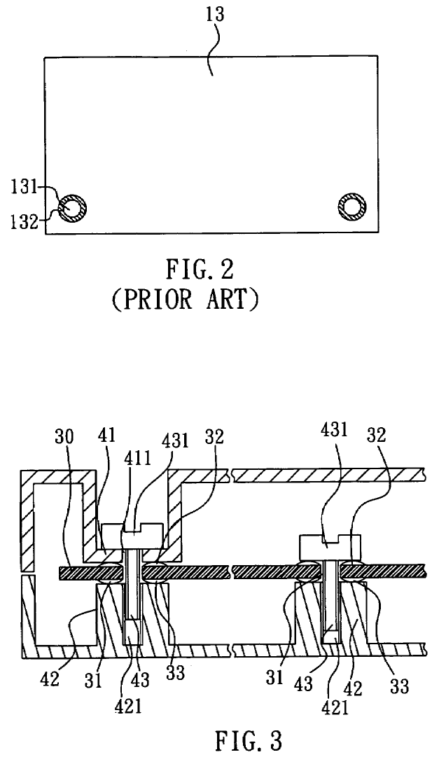

### DETAILED DESCRIPTION OF THE PREFERRED EMBODIMENTS

Please refer to FIG. 3. A structure and method for increasing a locking friction force on a circuit board of a first preferred embodiment according to the present invention are to form a upper connecting face 32 and lower connecting face 33 with an interlacing structure of a plurality of relative indented portions and raised portions at a position that a substrate 30 is sandwiched to fix by a first clamping part 41 and a second clamping part 42 or a position that the substrate 30 is sandwiched to fix by a nut 431 of a bolt 43 and the second clamping part 42, for example, at the surroundings of each through hole 31 allowing the bolt 43 to be passed through. The structure in which the relative indented and raised portions are interlaced allows the upper and the lower connecting faces 32 and 33 to have a larger friction coefficient. When the bolt 43 is passed through a through hole 411 of the first clamping part 41 and/or the through hole 31 of the substrate 30 and screwed into a screw hole 421 of the second clamping part 42 to cause the upper and lower faces 32 and 33 of the substrate 30 to be sandwiched by the first clamping part 41 and the second clamping part 42 or the upper and lower faces 32 and 33 of the substrate 30 to be sandwiched by the nut 431 of the bolt 43 and the second clamping part 42, a larger static friction force will be generated to cause a relative displacement between the substrate 30 and the first and the second clamping parts 41 and 42 rather not to be generated, and enable a component combined on the substrate 30 rather not to touch other components combined on a housing when the housing is dropped down onto a floor to cause soldering tin to be fallen off to loose functions or the components to be deformed to damage or fallen off to loose functions.

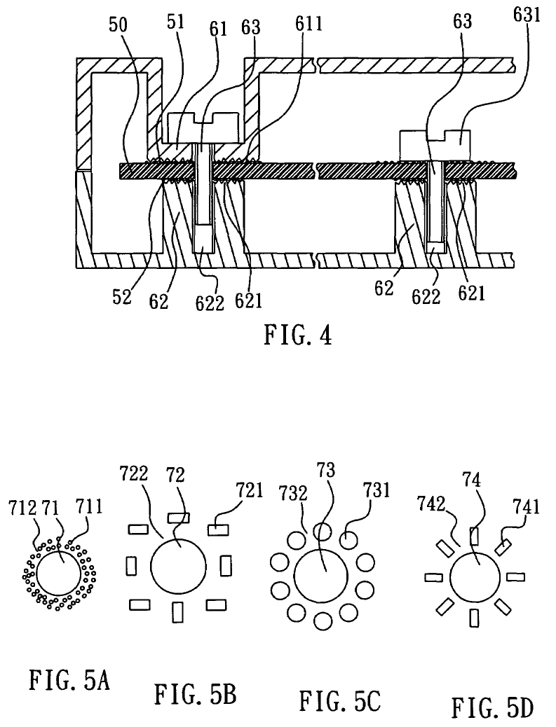

Please refer to FIG. 4. A structure and method for increasing a locking friction force on a circuit board of a second preferred embodiment according to the present invention further allow a first clamping part 61 and second clamping part 62 corresponding to a upper connecting face 51 and lower connecting face 52 of a substrate 50 respectively have knurling portions 611 and 621. When the bolt 63 is passed the through hole of the first clamping part 61 and/or the through hole of the substrate 50 to screw into the screw hole 622 of the second clamping part 62 to cause a larger static friction force to be yielded when the substrate 50 to be sandwiched by the first clamping part 61 and the second clamping part 62 or the substrate 50 is sandwiched by the nut 631 and the second clamping part 62; this allows relative displacements even more not to be generated between the substrate 50 and the first clamping portion 51 and the second clamping portion 62.

Please refer to FIGS. 5A, 5B, 5C and 5D. Structures of interlacing indented and raised portions on a connecting face of a substrate have various different types. For example, a plurality of tiny first portions 711, a plurality of rectangular first portions 721, a plurality of circular first portions 731 and a plurality of divergently arranged rectangular first portions 741 are respectively distributed on the surrounding areas of through holes 71, 72, 73 and 74, and rest areas thereof respectively are second portions 712, 722, 732 and 742.

The first portions 711, 721, 731 and 741 on the connecting faces of the substrates can respectively be raised portions, for example, those using metallic material such as tin or tin alloy capable of being stuck with a copper foil of a circuit board to form on a substrate, and more particularly to those integrated with the substrate at a soldering tin spreading step in the process of circuit board manufacturing; this needs no extra work and can further save the production cost. The metallic material can be other metals such as gold, silver and copper besides tin or tin alloy such as tin silver, tin zinc, tin silver bismuth, tin copper bismuth and tin zinc bismuth. And, the second portions 712, 722, 732 and 742 can be formed to be indented portions relative to the raised portions, for example, the face of the substrate lower than the raised portions. Otherwise, the first portions 711, 721, 731 and 741 can respectively indented potions, which are indentations formed by punching or drilling holes on the substrate. And the second portions 712, 722, 732 and 742 are raised portions formed on the face of the substrate relative to the indentions. The manufacturing methods mentioned above all allow the connecting face of each substrate to have indented portions and raised portions interlacing structure to increase the static friction coefficient on the connecting face of the substrate. Furthermore, the through holes 71, 72, 73 and 74 can be formed before, after or at the same time as the time that the connecting face is formed on each substrate.

There is no need for the present invention to use other fixing structure, only forming a connecting face with indented portions and raised portions interlacing structure on a substrate, it then allows the connecting face to have a larger friction coefficient and the substrate rather not to yield a displacement relatively to a clamping part when it is clamped to cause components combined on the substrate rather not to touch other components combined on a housing to cause soldering tin of the component to be fallen off to loose function or cause the component to be deformed, damaged or fallen off when the housing is dropped down onto the floor. Besides, the present invention allows the substrate to form the connecting face with a indented portions and raised portions interlacing structure thereon, the structure thereof is simple and the manufacturing thereof is easy, it can be formed at the same time when the soldering tin is spread on a circuit, and needs no extra work so that the production cost can be saved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A structure for increasing a locking friction force on a circuit board, allowing a larger friction coefficient to be existed at a position where a substrate is clamped; comprising:
said substrate, a connecting face being disposed on at least one of upper and lower faces thereof at said clamped position, said connecting face having a multiple relative indented portions and raised portions interlacing structure so as to allow said connecting face to have a larger friction coefficient, when said connecting face is clamped, a larger friction force being exerted thereon and a displacement relative to a clamper being rather not yielded.

2. The structure according to claim 1, wherein said raised portions are formed by protruding metallic material out of a face of said substrate.

3. The structure according to claim 2, wherein said metallic material is one of tin and tin alloy.

4. The structure according to claim 3, wherein said raised portions are formed with said circuit board at the same time in a soldering tin spreading step.

5. The structure according to claim 1, wherein a through hole is disposed at said position of said connecting face of said substrate so as to allow a rod or like to pass therethrough.

6. The structure according to claim 1, further comprising a first clamping part and second clamping part, said connecting face of said substrate is sandwiched between said first clamping part and said second clamping part.

7. The structure according to claim 6, wherein at least one of faces of said first and said second clamping parts contacting with said substrate has knurling lines.

8. The structure according to claim 1, wherein said indented portions is formed by holes indented on said substrate.

9. The structure according to claim 8, wherein said raised portions are formed by a face of said substrate.

10. The structure according to claim 1, wherein said circuit board is a printing circuit board.

11. A method for increasing a locking friction force on a circuit board, allowing a larger friction coefficient to be existed at a position where a substrate is clamped; comprising:
Allowing a connecting face with a multiple relative raised portions and indented portions interlacing structure to be formed on at least one of upper and lower faces of said substrate at said clamped position so as to allow said connecting face to have a larger friction coefficient, when said connecting face is clamped, a larger friction force being exerted thereon and a displacement relative to a clamper being rather not yielded.

12. The method according to claim 11, wherein said raised portions are formed by protruding metallic material out of a face of said substrate.

13. The method according to claim 12, wherein said metallic material is one of tin and tin alloy.

14. The method according to claim 13, wherein said raised portions are formed with said circuit board at the same time in a soldering tin spreading step.

15. The method according to claim 11, wherein a through hole is disposed at said position of said connecting face of said substrate so as to allow a rod or like to pass therethrough.

16. The method according to claim 11, further comprising a first clamping part and second clamping part, said connecting face of said substrate is sandwiched between said first clamping part and said second clamping part.

17. The method according to claim 16, wherein at least one of faces of said first and said second clamping parts contacting with said substrate has knurling lines.

18. The method according to claim 11, wherein said indented portions is formed by holes indented on said substrate.

19. The method according to claim 18, wherein said raised portions are formed by a face of said substrate.

20. The method according to claim 11, wherein said circuit board is a printing circuit board.
